(19) United States
(12) Patent Application Publication
(10) Pub. No.: US 2026/0241879 A1
(43) Pub. Date: Aug. 20, 2026

(54) INTEGRATED MODULE FOR A VEHICLE

(71) Applicant: MAGNA INTERNATIONAL INC., Aurora (CA)

(72) Inventors: Gert Edzko SMID, Oxford, MI (US); Cynthia M. WALLAT, Allen Park, MI (US); Cangji SHI, Oakland Township, MI (US); Jason A. DURFEE, Troy, MI (US)

(21) Appl. No.: 19/538,284

(22) Filed: Feb. 12, 2026

Related U.S. Application Data
(60) Provisional application No. 63/758,697, filed on Feb. 14, 2025.

(51) Int. Cl. B60R 16/027; B60R 16/02; B60R 16/023

(52) U.S. Cl. CPC B60R 16/027; B60R 16/0215; B60R 16/0231

(57) ABSTRACT

A sub-assembly for a vehicle includes: a structure defining a surface; an electronic control unit (ECU) having a printed circuit board (PCB) affixed directly to the surface of the structure; and a wiring harness directly and non-removably attached to the ECU and configured to connect the ECU to a plurality of sensors and actuators. An electronic control unit (ECU) for a vehicle component is also provided and includes: a printed circuit board (PCB) configured to be affixed directly to at least one of: a structural component of the vehicle component, or a trim panel of the vehicle component; and a processor attached to the PCB. The ECU further defines control interfaces to a plurality of sensors and actuators, and a communications interface for communicating with a remote controller.

### CROSS REFERENCE TO RELATED APPLICATIONS

This U.S. Utility Patent Application claims the benefit of U.S. Provisional Patent Application No. 63/758,697 filed Feb. 14, 2025, the contents of which is incorporated herein by reference in its entirety.

### FIELD

The present disclosure relates generally to electronic control units (ECUs) for onboard systems in vehicles. The present disclosure may be applicable to many different types of vehicles, such as passenger cars, trucks, busses, recreational vehicles, trains, motorcycles, etc. The present disclosure may be applicable to vehicles with any type of powertrain, including internal combustion engines, hybrid electric, plug-in electric, solar, etc.

### BACKGROUND

Vehicle manufacturers, also called original equipment manufacturers (OEMs), are increasingly interested in purchasing and assembling highly integrated modules, manufactured by suppliers, instead of purchasing and assembling all the discrete parts. This is reflected in increasing integration of vehicle modules, like Front-End, Doors, Trunk, Cabin, Fascia, etc.

Furthermore, there is a trend in the automotive industry away from conventional electrical and electronic (E/E) control architectures towards Zonal Architectures. This means that a single electronic control unit (ECU) is dedicated to managing sensors and actuators in a specific ‘Zone’ or Module of the vehicle. Traditional E/E control architectures tended to use dedicated ECU for each feature (with its sensors and actuators).

### SUMMARY

The present disclosure provides a sub-assembly for a vehicle. The sub-assembly includes: a structure defining a surface; an electronic control unit (ECU) having a printed circuit board (PCB) affixed directly to the surface of the structure; and a wiring harness directly and non-removably attached to the ECU and configured to connect the ECU to a plurality of sensors and actuators.

The present disclosure also provides an electronic control unit (ECU) for a vehicle component. The ECU comprises: a printed circuit board (PCB) configured to be affixed directly to at least one of: a structural component of the vehicle component, or a trim panel of the vehicle component; and a processor attached to the PCB. The ECU further defines control interfaces to a plurality of sensors and actuators, and a communications interface for communicating with a remote controller.

The present disclosure also provides a distributed electronic control system for a vehicle. The distributed electronic control system includes an electronic control unit (ECU) for a vehicle component. The ECU includes a printed circuit board (PCB) configured to be affixed directly to at least one of: a structural component of the vehicle component, or a trim panel of the vehicle component. The ECU further defines control interfaces to a plurality of sensors and actuators, and a communications interface for communicating with a remote controller in the vehicle. The distributed electronic control system includes a single power interface to the vehicle component, the single power interface being coupled directly to the ECU. The ECU is further configured to distribute power from the single power interface to the plurality of sensors and actuators.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings, in which a battery frame is disclosed.

FIG. 1 shows a perspective view of a flexible printed circuit board (PCB) for an electronic control unit (ECU), in accordance with an aspect of the disclosure.

FIG. 2A-2B each show wire connections to a PCB, in accordance with an aspect of the disclosure.

FIG. 3 shows a wire bonding connector for connecting a wire to a PCB of an ECU, in accordance with an aspect of the disclosure.

FIG. 4 shows a schematic block diagram illustrating interactions between sub-zonal control unit components in a side door of a vehicle.

FIG. 5 shows a traditional control architecture for a side door of a vehicle.

FIG. 6 shows a distributed electronic control system for a side door of a vehicle, in accordance with an aspect of the disclosure.

FIG. 7 shows a traditional control architecture for a side door of a vehicle with a mirror assembly having integrated electronics.

FIG. 8 shows a distributed electronic control system for a side door of a vehicle with a mirror assembly having integrated electronics, in accordance with an aspect of the disclosure.

FIG. 9 shows a traditional control architecture for a front fascia of a vehicle.

FIG. 10 shows a distributed electronic control system for a front fascia of a vehicle, in accordance with an aspect of the disclosure.

### DETAILED DESCRIPTION

Recurring features are marked with identical reference numerals in the figures, in which example embodiments are disclosed.

According to an aspect of the present disclosure, the present trend toward highly integrated control modules presents an opportunity to further integrate and optimize the manufacturing of a complete Module, beyond the traditional assembly process of individual components. Additionally or alternatively, the trend towards Zonal Architectures provides further opportunities to further integrate and optimize the functionality of a complete Module by hosting a single electronic control unit (ECU) for all electrical and electronic (E/E) content and providing a single interface for power and communication to the complete module.

According to an aspect of the present disclosure, sensors and/or actuators that may be integrated and interfaced to a single ECU include (but are not limited to): motors, latches, lights, cameras, radars, ultra-sonic sensors, pumps, horn, etc.

An objective of the present disclosure to provide an integrated module that architecture that saves costs by: 1) optimizing manufacturing and consolidating the [otherwise] discrete content, 2) reducing harness complexity and eliminating connectors, 3) eliminating mounting and assembling hardware by molding multiple parts into single modules. A disadvantage may be that individual components in the module may not be serviceable like they would be in a traditional assembled module.

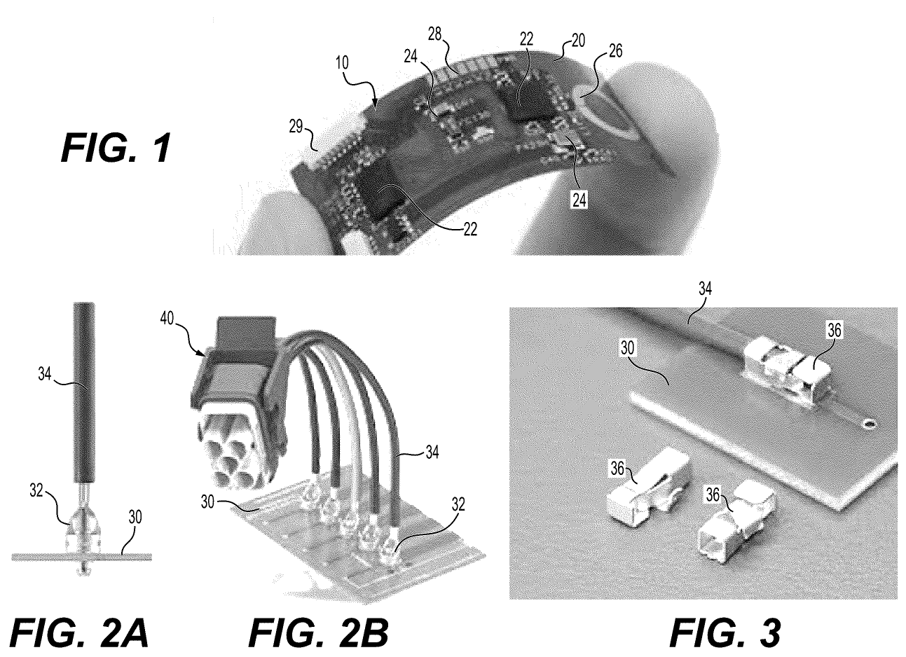

FIG. 1 shows a perspective view of a first printed circuit board (PCB) 10 for an ECU, in accordance with an aspect of the disclosure. The first PCB 10 includes a substrate 20 of flexible material that may be generally planar, but which can be bent without breaking. The substrate 20 may include several layers, including one or more conducive layers having a layout pattern to conduct electrical current between components, and which are separated by non-conductive layers. The first PCB 10 also includes a plurality of integrated circuits 22 and other electrical components 24, such as resistors and transistors, disposed on a surface of the substrate 20. In some embodiments, and as shown in FIG. 1, the first PCB 10 may include integrated antenna 26. The first PCB 10 may include several wiring pads 28 of conductive material on a surface of the substrate 20 for attachment to wires for external connections. In some embodiments, and as shown in FIG. 1, the first PCB 10 may include one or more connectors 29 mounted to a surface of the substrate and configured to receive and retain a cable, such as a ribbon cable, for making electrical connections with the first PCB 10.

FIG. 2A-2B each show wire connections to a second PCB 30. The second PCB 30 may be part of the first PCB 10. Alternatively, the second PCB 30 may be a separate part of an ECU. A first bonding connector 32 is used to connect a wire 34 to a surface of the second PCB 30, with the wire 34 extending perpendicularly to the surface of the second PCB 30. The first bonding connector 32 may be crimped to secure the wire 34. Alternatively or additionally, the wire 34 may be fixed to the first bonding connector 32 by soldering. In some embodiments, and as shown in FIG. 2B, a plug-in connector 40 is attached to the wires 34 opposite from the second PCB 30. Thus, the present disclosure may provide an ECU with a PCB having an integrated wiring harness that is configured to removably plug-in to one or more remote devices, such as sensors and/or actuators.

FIG. 3 shows a wire bonding connector for connecting a wire 34 to the second PCB 30. FIG. 3 shows a second bonding connector 36 for attaching the wire 34 to the second PCB 30 and so the wire 34 extends parallel to and along a surface of the second PCB 30. The second bonding connector 36 may be crimped to secure the wire 34. Alternatively or additionally, the wire 34 may be fixed to the second bonding connector 36 by soldering.

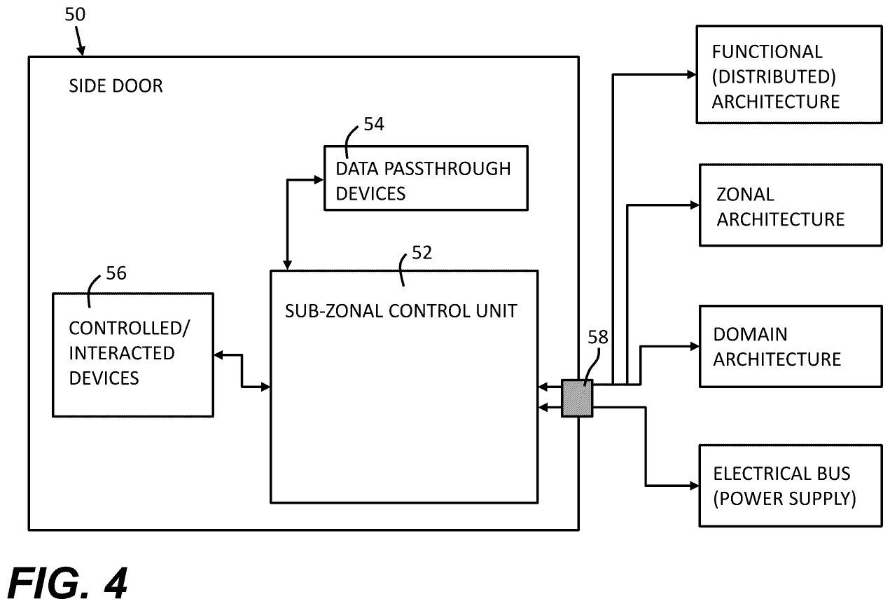

FIG. 4 shows a schematic block diagram illustrating interactions between sub-zonal control unit components in a side door 50 of a vehicle. The side door 50 is used as sub-system example, but the principles illustrated could be applied to other sub-system assemblies, such as a passenger door, a liftgate, a tailgate, a fascia, or another group of devices. As shown, the side door 50 includes a sub-zonal control unit 52 that is functionally connected to one or more data passthrough devices 54 in the side door 50 and to one or more controlled/interacted devices 56 in the side door 50. The side door 58 also includes a door grommet/connector 58 to provide data and/or power connections to external devices outside of the side door 50. The sub-zonal control unit 52 may include one or more physical connections, such as mounting on or to sheet metal of the door, in a latch assembly or in another control unit assembly. The sub-zonal control unit 52 may include one or more wire harness connectors. The door grommet/connector 58 may include fewer wires and/or connectors than are used in conventional side door connections.

The one or more data passthrough devices 54 in the side door 50 may include, for example, a Camera Monitor System (CMS) camera, a surround-view camera, an ADAS radar transceiver, one or more audio devices, such as speaker/amplifier units, a Passive Keyless Entry (PKE) transceiver, a Bluetooth low-energy (BLE) transceiver, and/or an Ultra-Wideband (UWB) radio transceiver, which may provide precise, secure, and real-time spatial awareness.

The one or more controlled/interacted devices 56 in the side door 50 may each be controlled and/or monitored by circuitry, such as a processor, located in the sub-zonal control unit 52. The one or more controlled/interacted devices 56 in the side door 50 may include, for example, a window regulator, a latch actuator, one or more power systems or power system integrated electronic control units (ECUs). Additionally or alternatively, the one or more controlled/interacted devices 56 in the side door 50 may include an outside mirror actuator, outside mirror lighting devices door panel lighting devices, interior handle input, window regulator switch input mirror switch input controls, active aero devices and/or seating control devices.

As shown on FIG. 4, the door grommet/connector 58 provides data and/or power connections between the sub-zonal control unit 52 and one or more external devices outside of the side door 50. The exterior devices may be arranged as a functional (distributed) architecture, which may use data transmission busses, such as CAN and/or LIN to provide connection to one or more body control modules. Alternatively or additionally, the exterior devices may be arranged as a zonal architecture, which may use one or more high-throughput data networks, such as CAN-FD, CAN-XL, or Ethernet to provide data connection between the sub-zonal control unit 52 and a zonal controller (not shown). In the zonal architecture, the sub-zonal control unit 52 may also act as a hub or a passthrough for signals to/from the zonal controller. Alternatively or additionally, the exterior devices may be arranged as a domain architecture, which may use one or more high-throughput data networks, such as CAN-FD, CAN-XL, or Ethernet, such as 10Base-T1S to provide data connection between the sub-zonal control unit 52 and a domain controller (not shown). In the domain architecture, the sub-zonal control unit 52 may also act as a hub or a passthrough for signals to/from the domain controller.

Alternatively or additionally, the exterior devices may include an electrical bus, which may function as a power supply and which may include one or more electronic fuses and/or traditional fuses for supplying power to the sub-zonal control unit 52.

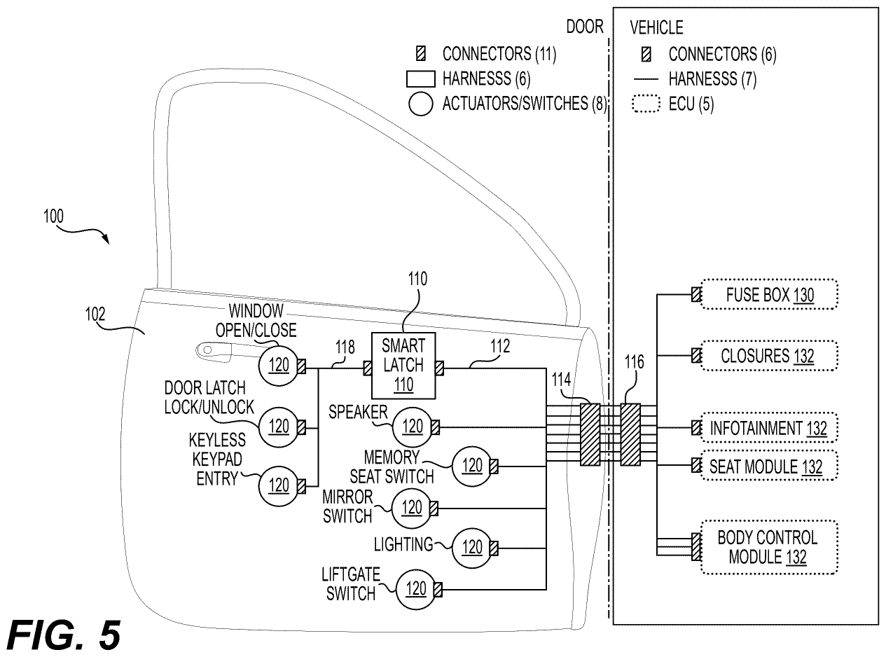

FIG. 5 shows a traditional control architecture 100 for a side door 102 of a vehicle. The traditional control architecture includes an ECU in the side door and which is embedded in a smart latch assembly 110. A first wiring harness 112 connects the side door 102 to a body of the vehicle. The first wiring harness 112 includes a door-side connector 114 and a corresponding body-side connector 116. The first wiring harness 112 includes a large number of wires to transmit power and signals to each of several different sensors and actuators 120. The first wiring harness 112 also connects the side door 102 to a fuse box 130 and several different body-side controllers 132 located in the body of the vehicle. The body-side controllers 132 may include a closures controller, an infotainment system module, a seat module, and a body control module (BCM). The traditional control architecture 100 also includes a second wiring harness 118 with connectors for connecting the smart latch assembly 110 to additional sensors and actuators 120, such as switches for controlling the window, door latch controls, and a keyless keypad entry.

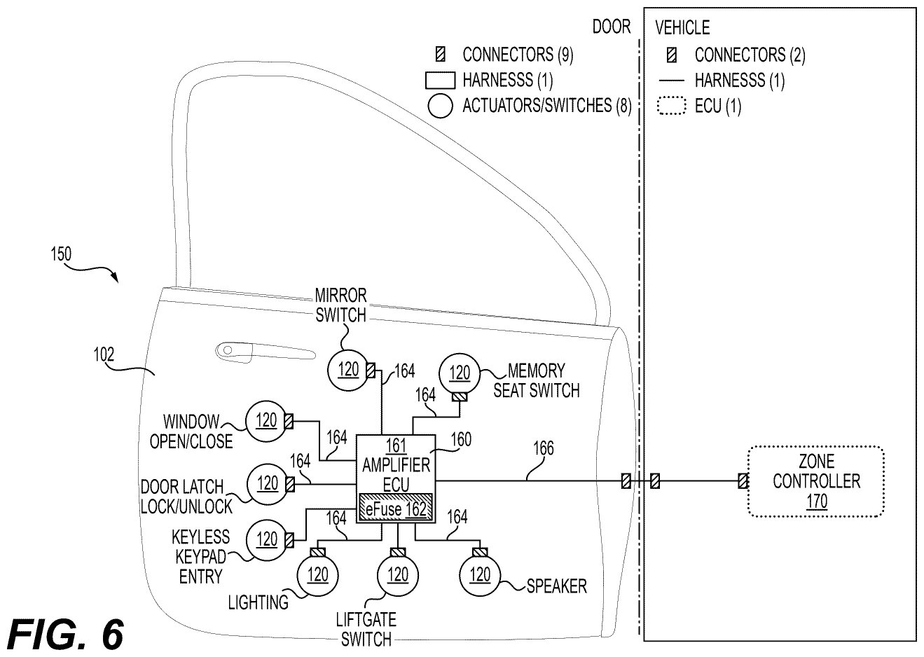

FIG. 6 shows a first distributed electronic control system 150 for a side door 102 of a vehicle, in accordance with an aspect of the disclosure. The first distributed electronic control system 150 includes a first ECU 160 that configured to interface with each of the sensors and actuators 120 located in the side door 102. The first ECU 160 includes a PCB 161 that is configured to be affixed directly to a structural component or a trim panel of the side door 102. The first ECU 160 also includes a plurality of electronically-resettable fuses (e-fuses), which are each configured to provide power to corresponding ones of the sensors and actuators 120, and which are each resettable in response to a signal from a processor in the first ECU 160.

The first ECU 160 includes several integrated wiring connectors 164, each having a plug on an end opposite from the PCB 161 and for removably plugging into corresponding ones of the sensors and actuators 120. The first ECU 160 also includes a main connector 166 having a wiring plug on an end opposite from the PCB 161 and for connection to power and signals from a zone controller 170 in the body of the vehicle.

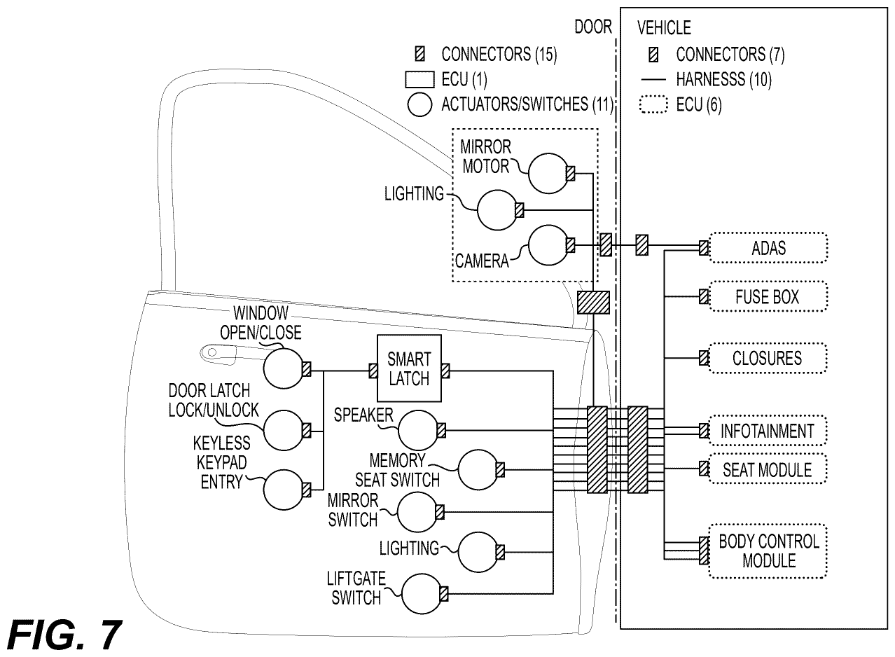

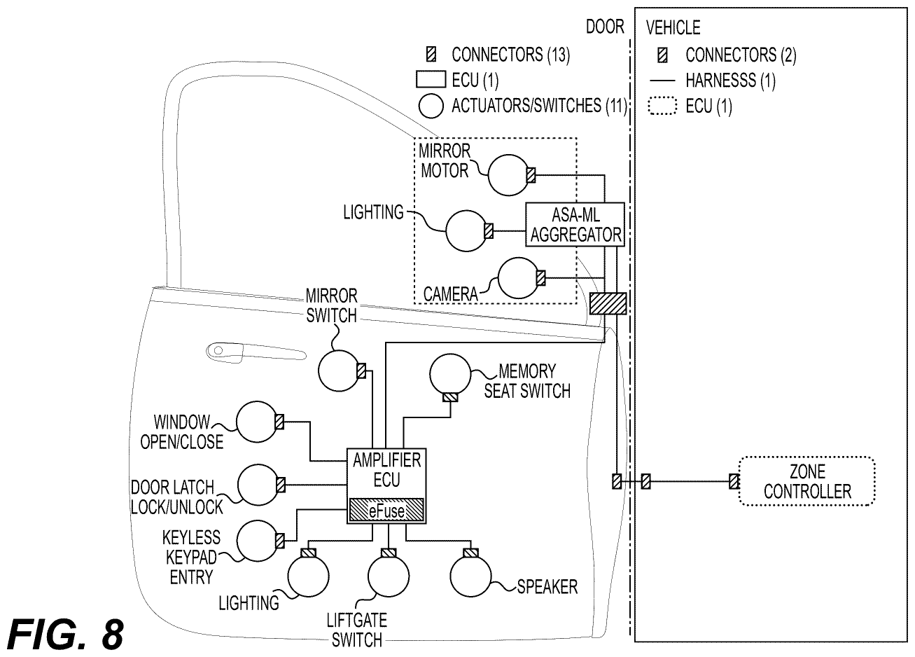

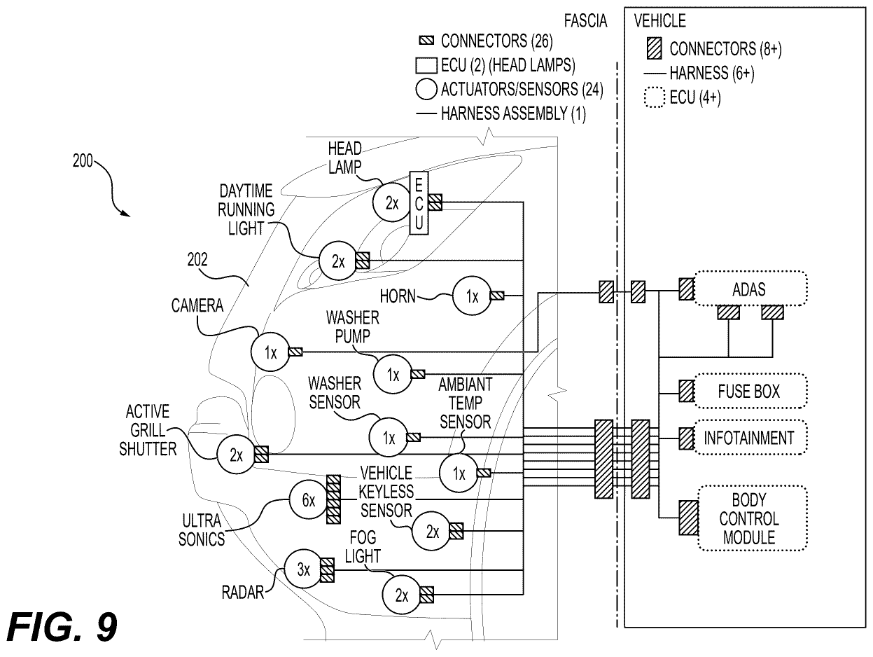

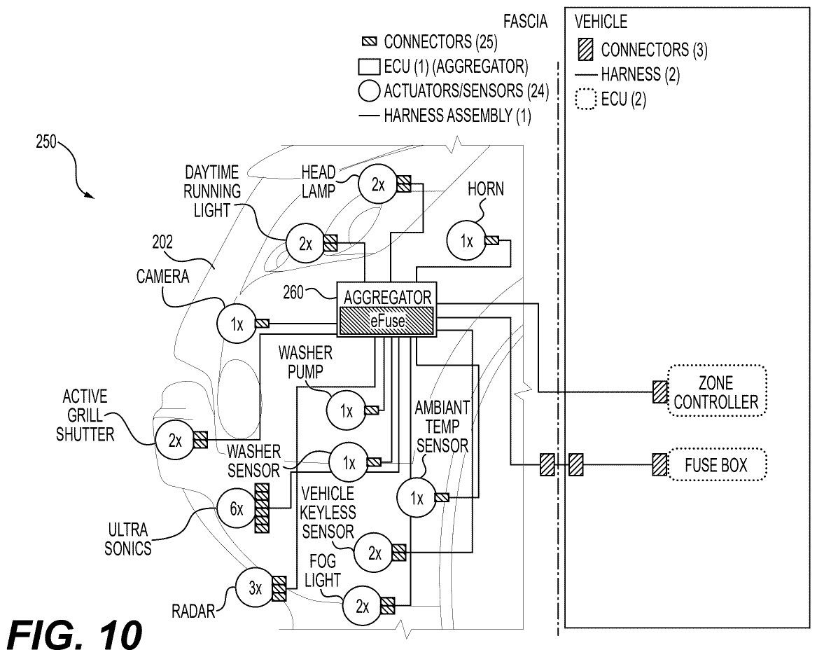

FIG. 7 shows a traditional control architecture for a side door of a vehicle with a mirror assembly having integrated electronics. FIG. 8 shows a distributed electronic control system for a side door of a vehicle with a mirror assembly having integrated electronics, in accordance with an aspect of the disclosure. FIG. 9 shows a traditional control architecture 200 for a front fascia 202 of a vehicle. FIG. 10 shows a second distributed electronic control system 250 for the front fascia 202 of a vehicle, in accordance with an aspect of the disclosure.

Similarly to a closure, such as a passenger door, a fascia and/or other vehicle component may include numerous sensors and actuators and can benefit from the distributed electronic control systems of the present disclosure. For example, the front fascia 202 includes headlamp assemblies, fog light assemblies, daytime running lights, a horn, a camera, an active grille shutter, ultrasonic sensors, radar sensors, keyless entry sensors, an ambient temperature sensor, and a washer pump. Each of those electronic devices 210 can be connected to the ECU of the present disclosure via an integrated wiring connector.

The second distributed electronic control system 250 includes a second ECU 260 that is configured to interface with each of the sensors and actuators located in the front fascia 202. The second ECU 260 may have a similar or identical configuration as the first ECU 160 of the side door 102, except with connector hardware that is customized for the specific sensors and actuators of the front fascia 202. Additionally or alternatively, the second ECU 260 may have onboard circuitry, such as e-fuses, that is also customized to interface with the sensors and actuators of the front fascia 202.

The ECUs 160, 260 of the present disclosure may be integrated with or affixed to any vehicle surface materials, such as sheet metal with a non-conductive coating, plastic surfaces, insulation surfaces, etc. Each of the ECUs 160, 260 of the present disclosure may define a sub-zonal region for a zone controller in the vehicle.

The distributed electronic control systems 150, 250 each provides a vast reduction in wiring for both power distribution and signal communications both within the vehicle component and between the vehicle component and other systems of the vehicle outside of the vehicle component.

The present disclosure provides a sub-assembly for a vehicle. The sub-assembly includes: a structure defining a surface; an electronic control unit (ECU) having a printed circuit board (PCB) affixed directly to the surface of the structure; and a wiring harness directly and non-removably attached to the ECU and configured to connect the ECU to a plurality of sensors and actuators.

In some embodiments, the structure includes at least one of a structural component or a trim panel. The structure of the sub-assembly may include, for example, a fascia or a door trim panel. However, these are merely examples, and other structures may be used, such as a dashboard, a seat, or a body panel.

In some embodiments, the structure defines class-A surface that is configured to be directly viewed and/or touched by a user, and wherein the PCB is affixed to the surface of the structure opposite of the class-A surface.

In some embodiments, the structure is a component for a body panel of the vehicle, and wherein the plurality of sensors and actuators are attached to the body panel of the vehicle. The component for the body panel may include, for example, a front fascia, a rear fascia, or a roof headliner. These are merely examples, and other components for body panels may be used.

In some embodiments, the structure is a component for a closure of the vehicle, and wherein the plurality of sensors and actuators are attached to the closure of the vehicle. For example, the closure of the vehicle may include at least one of a passenger door, a liftgate, or a tailgate.

In some embodiments, the ECU further includes a plurality of electronically-resettable fuses (e-fuses), wherein each e-fuse of the plurality of e-fuses is configured to provide power to a corresponding one of the plurality of sensors and actuators, and wherein each e-fuse of the plurality of e-fuses is configured to be reset by a command from a processor.

In some embodiments, the PCB is flexible to conform to a profile of the surface.

In some embodiments, the PCB is affixed directly to the surface of the structure using an adhesive material.

The present disclosure also provides an electronic control unit (ECU) for a vehicle component. The ECU comprises: a printed circuit board (PCB) configured to be affixed directly to at least one of: a structural component of the vehicle component, or a trim panel of the vehicle component; and a processor attached to the PCB. The ECU further defines control interfaces to a plurality of sensors and actuators, and a communications interface for communicating with a remote controller.

In some embodiments, the PCB may be configured to be affixed directly to the structural component of the vehicle component. For example, the PCB may be glued or otherwise affixed to a structural frame component or a door module carrier in a door panel of the vehicle. In another example, the PCB may be attached using ultrasonic welding or a snap-fit connection to a plastic structure of the vehicle component.

In some embodiments, the PCB may be configured to be affixed directly to the trim panel of the vehicle component. For example, the PCB may be glued or otherwise affixed to the trim panel.

In some embodiments, the PCB may be configured to be affixed to a surface of the trim panel opposite of a class-A surface that is configured to be directly viewed and/or touched by a user. For example, the PCB may be glued or otherwise affixed to an interior surface of the trim panel, opposite from the class-A surface.

In some embodiments, the ECU is located in a closure of the vehicle, and wherein the plurality of sensors and actuators are attached to the closure of the vehicle. For example, the closure of the vehicle may include at least one of a passenger door, a liftgate, or a tailgate.

In some embodiments, the ECU further includes a plurality of electronically-resettable fuses (e-fuses), wherein each e-fuse of the plurality of e-fuses is configured to provide power to a corresponding one of the plurality of sensors and actuators, and wherein each e-fuse of the plurality of e-fuses is configured to be reset by a command from the processor.

In some embodiments, the ECU further includes a plurality of connectors each configured to non-removably affix one or more wires to the PCB.

In some embodiments, the ECU includes no connectors for removable attachment of wiring directly to the PCB. Wiring connectors and pigtail wires may be non-removably attached to the PCB and configured to plug-in to each of the plurality of sensors and actuators.

In some embodiments, the PCB may be flexible to conform to a profile of the at least one of the structural component of the vehicle component, or the trim panel of the vehicle component.

In some embodiments, the ECU may include a conformal coating over the PCB to prevent water or other contaminants from contacting the PCB or components attached thereto.

In some embodiments, the PCB may be configured to be affixed directly to the at least one of: the structural component of the vehicle component, or the trim panel of the vehicle component using an adhesive material.

In some embodiments, the PCB may be configured to be affixed directly to the at least one of: the structural component of the vehicle component, or the trim panel of the vehicle component using a latching or a snap fit. For example, the structural component or the trim panel may include one or more retaining features integrally molded therein and which are arranged to receive and to retain the PCB. In some embodiments, the one or more retaining features may include latches or catches configured to detachably hold the PCB. Alternatively or additionally, the one or more retaining features may include structures that are configured to be melted or otherwise deformed to permanently retain the PCB. Permanent retaining may refer to a retaining feature that cannot be removed using non-destructive techniques.

The present disclosure also provides a distributed electronic control system for a vehicle. The distributed electronic control system includes an electronic control unit (ECU) for a vehicle component. The ECU includes a printed circuit board (PCB) configured to be affixed directly to at least one of: a structural component of the vehicle component, or a trim panel of the vehicle component. The ECU further defines control interfaces to a plurality of sensors and actuators, and a communications interface for communicating with a remote controller in the vehicle. The distributed electronic control system includes a single power interface to the vehicle component, the single power interface being coupled directly to the ECU. The ECU is further configured to distribute power from the single power interface to the plurality of sensors and actuators.

According to an aspect of the present disclosure, cost and integration may each be optimized by “molding” an ECU directly into a panel of an Integrated Module. The ECU would, therefore, not be considered as a separate product. This may allow elimination of: the enclosure, the connectors on the PCB and on the harness to the ECU, the mounting hardware. The solutions of the present disclosure may also save assembly cost and save space.

In some embodiments, wires can be installed directly on the PCB by soldering or crimping or wire splicing. In some embodiments, the PCB can be flexible to adhere to the shape of the panel that it is mounted to. In some embodiments, the PCB may be spray-coated with a protective layer to avoid corrosion and oxidation. In some embodiments, the PCB may be molded or glued or snapped in to the [interior] panel of the Module. In some embodiments, the PCB may have a processor to manage the interfaces to sensors and actuators and handle the communication with the vehicle controller.

In some embodiments, the Integrated Module will only need to interface Power and Communication with the vehicle. In some embodiments, the ECU may have integrated e-Fuses on the PCB to provide power protection to individual actuators inside the Module. In some embodiments, the software on the ECU can be updated over the communication interface to the vehicle. In some embodiments, the ECU (and its software) may support all regulatory and functional safety and cyber security requirements as stated by Automotive standards.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sub-assembly for a vehicle, comprising:
a structure defining a surface;
an electronic control unit (ECU) having a printed circuit board (PCB) affixed directly to the surface of the structure; and
a wiring harness directly and non-removably attached to the ECU and configured to connect the ECU to a plurality of sensors and actuators.

2. The sub-assembly of claim 1, wherein the structure includes at least one of a structural component or a trim panel.

3. The sub-assembly of claim 1, wherein the structure defines class-A surface that is configured to be directly viewed and/or touched by a user, and wherein the PCB is affixed to the surface of the structure opposite of the class-A surface.

4. The sub-assembly of claim 1, wherein the structure is a component for a body panel of the vehicle, and wherein the plurality of sensors and actuators are attached to the body panel of the vehicle.

5. The sub-assembly of claim 1, wherein the structure is a component for a closure of the vehicle, and wherein the plurality of sensors and actuators are attached to the closure of the vehicle.

6. The sub-assembly of claim 5, wherein the closure of the vehicle includes at least one of a passenger door, a liftgate, or a tailgate.

7. The sub-assembly of claim 1, wherein the ECU further includes a plurality of electronically-resettable fuses (e-fuses), wherein each e-fuse of the plurality of e-fuses is configured to provide power to a corresponding one of the plurality of sensors and actuators, and wherein each e-fuse of the plurality of e-fuses is configured to be reset by a command from a processor.

8. The sub-assembly of claim 1, wherein the PCB is flexible to conform to a profile of the surface.

9. The sub-assembly of claim 1, wherein the PCB is affixed directly to the surface of the structure using an adhesive material.

10. The sub-assembly of claim 1, wherein the PCB is affixed directly to the surface of the structure using a latching or a snap fit.

11. An electronic control unit (ECU) for a vehicle component, comprising:
a printed circuit board (PCB) configured to be affixed directly to a surface of at least one of: a structural component of the vehicle component, or a trim panel of the vehicle component; and
a processor attached to the PCB,
wherein the ECU further defines control interfaces to a plurality of sensors and actuators, and a communications interface for communicating with a remote controller.

12. The ECU of claim 11, wherein the at least one of the structural component of the vehicle component, or the trim panel of the vehicle component defines class-A surface that is configured to be directly viewed and/or touched by a user, and wherein the PCB is configured to be affixed to the surface of the structure opposite of the class-A surface.

13. The ECU of claim 11, wherein the ECU is located in a closure of the vehicle, and wherein the plurality of sensors and actuators are attached to the closure of the vehicle.

14. The ECU of claim 13, wherein the closure of the vehicle includes at least one of a passenger door, a liftgate, or a tailgate.

15. The ECU of claim 11, wherein the ECU further includes a plurality of electronically-resettable fuses (e-fuses), wherein each e-fuse of the plurality of e-fuses is configured to provide power to a corresponding one of the plurality of sensors and actuators, and wherein each e-fuse of the plurality of e-fuses is configured to be reset by a command from the processor.

16. The ECU of claim 11, wherein the ECU further includes a plurality of connectors each configured to non-removably affix one or more wires to the PCB.

17. The ECU of claim 11, wherein the ECU includes no connectors for removable attachment of wiring directly to the PCB.

18. The ECU of claim 11, wherein the PCB is flexible to conform to a profile of the at least one of the structural component of the vehicle component, or the trim panel of the vehicle component.

19. The ECU of claim 11, further comprising a conformal coating over the PCB to prevent water or other contaminants from contacting the PCB or components attached thereto.

20. A distributed electronic control system for a vehicle, comprising:
an electronic control unit (ECU) for a vehicle component, the ECU including a printed circuit board (PCB) configured to be affixed directly to at least one of: a structural component of the vehicle component, or a trim panel of the vehicle component,
wherein the ECU further defines control interfaces to a plurality of sensors and actuators, and a communications interface for communicating with a remote controller in the vehicle,
wherein the distributed electronic control system includes a single power interface to the vehicle component, the single power interface being coupled directly to the ECU, and
wherein the ECU is further configured to distribute power from the single power interface to the plurality of sensors and actuators.
